(19) United States
(12) Patent Application Publication
(10) Pub. No.: US 2003/0099508 A1
(43) Pub. Date: May 29, 2003

(54) Device for assembling separable toothbrush elements

(76) Inventor: Jean-Luc Lefevre, Beauvais (FR)

Correspondence Address: Finnegan Henderson Farabow, Garrett & Dunner, 1300 I Street NW, Washington, DC, 20005, US

(21) Appl. No.: 10/203,410

(22) PCT Filed: Jan. 11, 2001
(86) PCT No.: PCT/FR01/00079

(30) Foreign Application Priority Data
Feb. 10, 2000 (FR) 00/01641

(51) Int. Cl. A46B 7/04; B25G 3/00

(52) U.S. Cl. 403/329; 15/145; 15/176.1

(57) ABSTRACT

The invention concerns a toothbrush whereof the neck (1) is provided with a centring spindle having a snap-on tab (2) at its end secured in a hole (4) of the handle (3). The handle is hollowed out over its entire length with a cylindrical orifice for housing a push element whereof the stem (10) is provided with unlocking wedges (14) to disengage the snap-on tab and the handle. The invention is applicable to toothbrushes produced in several separable parts.

The invention relates to toothbrushes made in several separable parts and it more especially concerns a device for assembling these members which enables the head and the sleeve to be separated by means of a simple, precise operation and which, at the same time, discretely blends in with the aesthetics and ergonomics of the toothbrush.

There is a wide variety of devices for snap fitting the head of a toothbrush onto a handle, but these often require the user to perform a delicate operation in order to separate the members of the brush or, on the contrary, they do not ensure that the assembly stays held together during brushing, the locking device being located in the zone on which the thumb and forefinger bear, or not sufficiently retaining the constituents of the toothbrush when it is used.

The Applicant has devoted itself to solving these problems by producing a device for assembling the separable members of an object such as a toothbrush, a device which ensures positive, robust assembly of these members and necessitates only a very simple operation in order to dismantle the whole, without excessive effort. The device is particularly adaptable to toothbrushes for children.

The main object of the invention is thus a device for assembling separable components of a toothbrush comprising a head, a neck and a handle, wherein the neck of the brush has a centring pin ending in a snap fitting tab fastening in a well in the handle, said handle presenting, over its entire length, a cylindrical opening serving to house a pusher projecting out of the handle, and comprising releasing wedges for separating the snap fitting tab from the handle.

According to other particular characteristics of the invention, the end of the snap fitting tab present chamfers converging towards the axis of the well, and said tab fastens onto shoulders of the well.

Advantageously, the releasing wedges enveloping a central recess are mounted on the end of the shank of the pusher, in the vicinity of the chamfers of the snap fastening tab.

Further characteristics and advantages of the invention will emerge from the description that follows of a non-limitative exemplary embodiment in which reference is made to the annexed drawings, wherein:

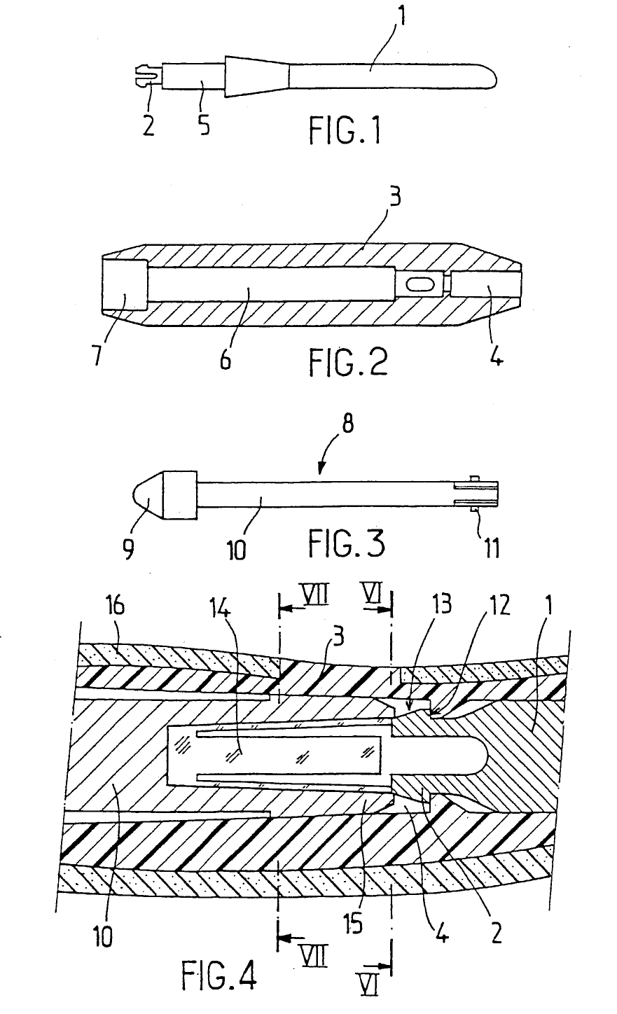

FIGS. 1 to 3 are general elevation views of the head, the handle and the pusher of the toothbrush, respectively;

FIG. 4 is a larger scale longitudinal cross-sectional view of the central part, showing the assembly device;

FIG. 5 is a larger scale longitudinal cross-sectional view of this central part in a plane perpendicular to the previous one;

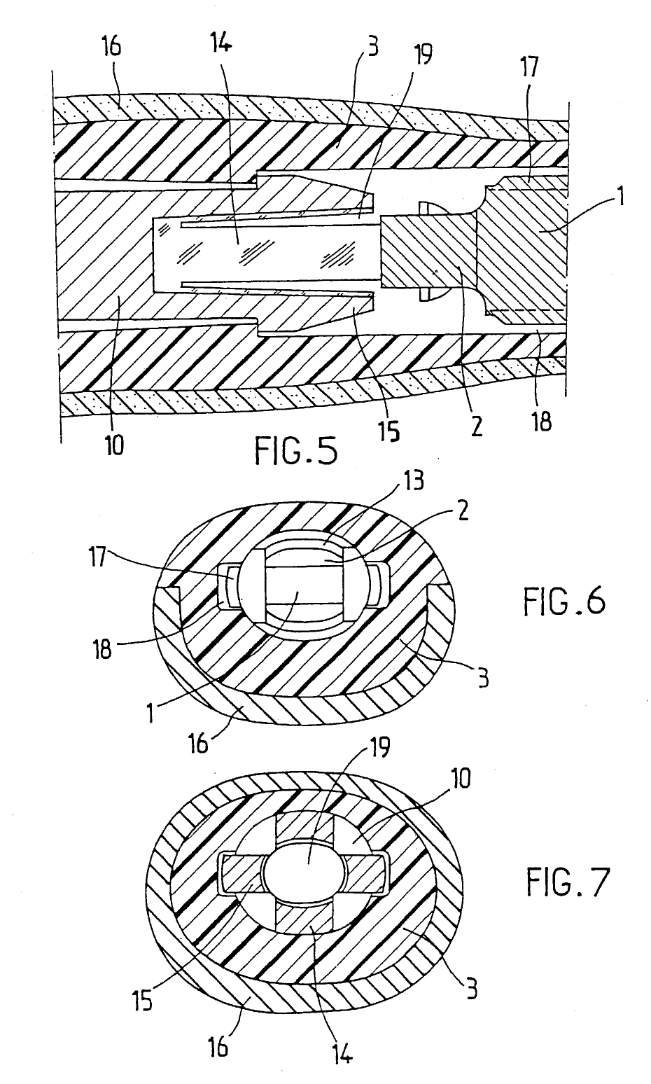

FIGS. 6 and 7 are cross-sectional views along lines VI-VI and VII-VII, respectively, of FIG. 4.

FIG. 1 shows the head 1 of a toothbrush constituting an independent member whereof one end, forming a neck, is provided with a snap fastening tab 2 at the end of a centring pin 5, which tab is designed to fasten to a handle 3, shown in FIG. 2. The handle, which has a cylindrical cross-section, is provided, for this purpose, with an end well 4 capable of receiving pin 5 of the head. Furthermore, over its entire length the handle presents a cylindrical opening 6 whereof the end, opposite from well 4, ends in a larger diameter cavity 7. The opening and the cavity of the handle serve to house a pusher 8, projecting from the handle, which is shown in FIG. 3. The pusher is essentially composed of a button 9 at the end of a shank 10, the end of which bears anti-rotation studs 11. FIGS. 4 to 7 illustrate the central snap fitting zone between head 1 and handle 3. It can be seen that tab 2 fastens onto shoulders 12 provided in well 4 of the handle. In addition, the end of tab 2 has chamfers 13 converging towards the axis of the well. Furthermore, anti-rotation guides 17 are provided on the sides of head 1 and co-operate with grooves 18 provided in the handle.

The end of shank 10 of pusher 8 is provided externally with releasing wedges 14 and internally with elastic tongues 15 enveloping a central recess 19 and ensuring that the pusher is retained in the handle. Finally, the outside of handle 3 is surrounded by an elastomeric sleeve which contributes to the aesthetic appearance of the brush.

In the position shown in FIGS. 4 and 5, tab 2, bearing against shoulders 12, holds handle 3 and head 1 of the toothbrush rigidly snap fastened together. When the user wishes to separate these two pieces, he or she exerts a pressure on button 9 of pusher 8, which projects from cavity 7. The thrust exerted on shank 10 and releasing wedges 14 forces the latter to ride up over chamfers 13 of tab 2 and thus arch the wings of the tab inwards, causing it to be released from shoulders 12. In this way, it is easy to detach the head from the handle.

Elastomeric ring 16, which is advantageously coloured, contributes to the aesthetic appearance and guarantees the tightness of the assembled whole, thus creating a barrier against the infiltration of water mixed with dentifrice and saliva.

1. Device for assembling separable members of a toothbrush, comprising a head, a neck and a handle, characterised in that the neck of the brush has a centring pin (5) ending in a snap fastening tab (2) fastening in a well (4) of the handle (3), and in that said handle presents, over its entire length, a cylindrical opening (6) serving to house a pusher (8) projecting out of the handle, and comprising releasing wedges (14) for detaching the snap fastening tab from the handle.

2. Assembling device according to claim 1, characterised in that the end of the snap fastening tab (2) has chamfers (13) converging towards the axis of the well (4) and in that said tab fastens onto shoulders (12) of the well.

3. Assembling device according to claim 1, characterised in that the pusher (8) is constituted by a button (9) at the end of a shank (10), the end of which bears anti-rotation studs (11).

4. Assembling device according to claims 1 and 2, characterised in that the releasing wedges (14) enveloping a central recess (19) are mounted on the end of the shank (10) of the pusher (8), in the vicinity of the chamfers (13) of the snap fastening tab (2).
